(19) United States
(12) Patent Application Publication
(10) Pub. No.: US 2018/0236281 A1
(43) Pub. Date: Aug. 23, 2018

(54) MOBILE FIREFIGHTNG UNIT

(71) Applicant: Daniel JUTRAS, Mont-Saint-Hilaire (CA)

(72) Inventor: Daniel JUTRAS, Mont-Saint-Hilaire (CA)

(21) Appl. No.: 15/753,427

(22) PCT Filed: Aug. 19, 2016
(86) PCT No.: PCT/CA2016/050973

§ 371 Date: Feb. 19, 2018

Related U.S. Application Data
(60) Provisional application No. 62/207,086, filed on Aug. 19, 2015.

(51) Int. Cl. A62C 3/02; A62C 25/00; A62C 27/00

(52) U.S. Cl. CPC A62C 3/0292; A62C 5/002; A62C 27/00; A62C 25/005

(57) ABSTRACT

There is provided a mobile firefighting unit comprising a container having a reservoir portion and a utility portion. The reservoir portion comprises a reservoir for storing a fluid. The utility portion comprises a main pumping station in fluid communication with the reservoir, and a mobile pumping station connectable to the main pumping station through a hose extending outside the container. The mobile pumping station is deployable for firefighting purposes. A heating system is also positioned within the container for heating the interior of the container. A lighting system provides lighting for the interior of the container. The mobile firefighting unit is readily and quickly available for rapid deployment in a fire scenario under various climate conditions.

### TECHNICAL FIELD OF THE INVENTION

The technical field relates to a mobile firefighting unit. In particular, the technical field relates to a self-contained mobile firefighting unit.

### BACKGROUND

Firefighting in isolated, rural or remote areas, such as the ones found in Nordic villages of Canada, represent several challenges. In such areas, there is often no infrastructure for efficient firefighting, such as aqueduct and fire hydrants. In addition, access to a water source can be problematic in the event a fire occurs in a dry area or during cold-weather seasons.

This can become an issue when a fire occurs and when there is a delay in obtaining help from fire department or emergency services. Such situations can lead to losses of life, and significant damages to the infrastructures affected by the fire.

There is therefore a need for a self-contained mobile firefighting unit that would readily provide water and essential tools to firefighting personnel for rapid deployment in the event of a fire in such isolated, rural or remote areas.

### BRIEF SUMMARY OF THE INVENTION

It is therefore an aim of the present invention to address the above mentioned issues.

In accordance with an aspect, there is provided a mobile firefighting unit comprising a container having a reservoir portion and a utility portion, the reservoir portion comprising a reservoir for storing a fluid and the utility portion comprising a main pumping station in fluid communication with the reservoir, and a mobile pumping station connectable to the main pumping station through a primary hose extending outside the container, the mobile pumping station being deployable for firefighting purposes.

In accordance with another aspect, therein provided a method for operating a mobile firefighting unit comprising a container having a reservoir portion and a utility portion, the reservoir portion comprising a reservoir for storing a fluid and the utility portion comprising a main pumping station in fluid communication with reservoir and a mobile pumping station connectable to the container through a primary hose extending outside the container. The method includes displacing the mobile pumping station from the utility portion of the container of the mobile firefighting unit to a location outside the container, further displacing the mobile pumping station to a firefighting site remote of the container, after displacing the mobile pumping station to the firefighting site, operating a main pumping station at the container to begin providing the fluid from the reservoir of the container to the mobile pumping station via the primary hose and operating at least one secondary hose of the mobile pumping station to cause the fluid to be exited for firefighting.

### BRIEF DESCRIPTION OF THE FIGURES

These and other objects and advantages of the invention will become apparent upon reading the detailed description and upon referring to the drawings.

FIG. 1 is a perspective view of a mobile firefighting unit, in accordance to an embodiment of the present invention.

FIG. 2 is a plan view of the mobile firefighting unit of FIG. 1.

FIG. 3 is a perspective partially translucent view of a utility portion of the mobile firefighting unit of FIG. 1.

FIG. 4 is a perspective partially translucent view of the utility portion of the mobile firefighting unit of FIG. 1.

FIG. 5 is an elevation view of a left end of the mobile firefighting unit of FIG. 1, with a left end wall being translucent and with the primary door being open;

FIG. 6 is a perspective view of the container of the mobile firefighting unit according to one embodiment;

FIG. 7 is an elevation view of a right end of the mobile firefighting unit according to one embodiment;

FIG. 8 is an elevation view of an interior of the utility portion of the mobile firefighting unit showing a main pumping station according to one embodiment;

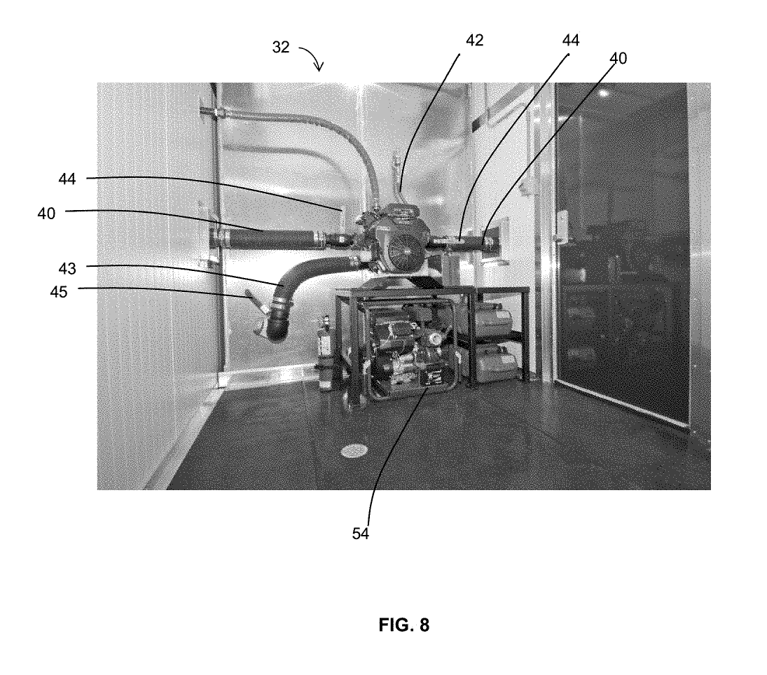

FIG. 9 is a side elevation view of a mobile pumping station according to one embodiment;

FIG. 10 is a rear elevation view of the mobile pumping station according to one embodiment;

FIG. 11 is a rear perspective view of the mobile pumping station in operation according to one embodiment; and

FIG. 12 is a plan view of the mobile pumping station in operation according to one embodiment.

It will be noted that throughout the appended drawings, like features are identified by like reference numerals.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

In addition, although the optional configurations as illustrated in the accompanying drawings comprises various components and although the optional configurations of the mobile firefighting unit as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the mobile firefighting unit, and corresponding parts, as briefly explained and as can be easily inferred herefrom, without departing from the scope of the disclosure.

“Protected site” herein refers to a geographical region that can be served by a mobile firefighting unit 10 described herein according to various example embodiments. For example, a protected site may be a geographically remote location such as a town, village, military base, or mining operation.

“Firefighting site” herein refers to a site within a protected site that needs to be served or is currently being served by the mobile firefighting unit 10 of the protected site. For example, the firefighting site may be a sub-region of the protected site where a firefighting situation is occurring, corresponding to a fire that needs to be fought. The firefighting site may be located remotely of the stationary location of the container 12 of the protected site.

A “deployment-ready state” of the mobile firefighting unit 10 or elements thereof refers to a state in which the mobile firefighting unit 10 is ready to be deployed in response to a firefighting situation at a protected site.

A “deployed state” of the mobile firefighting unit 10 or elements thereof refers to a state in which one or more elements of the mobile firefighting unit 10 has been deployed in response to a firefighting situation.

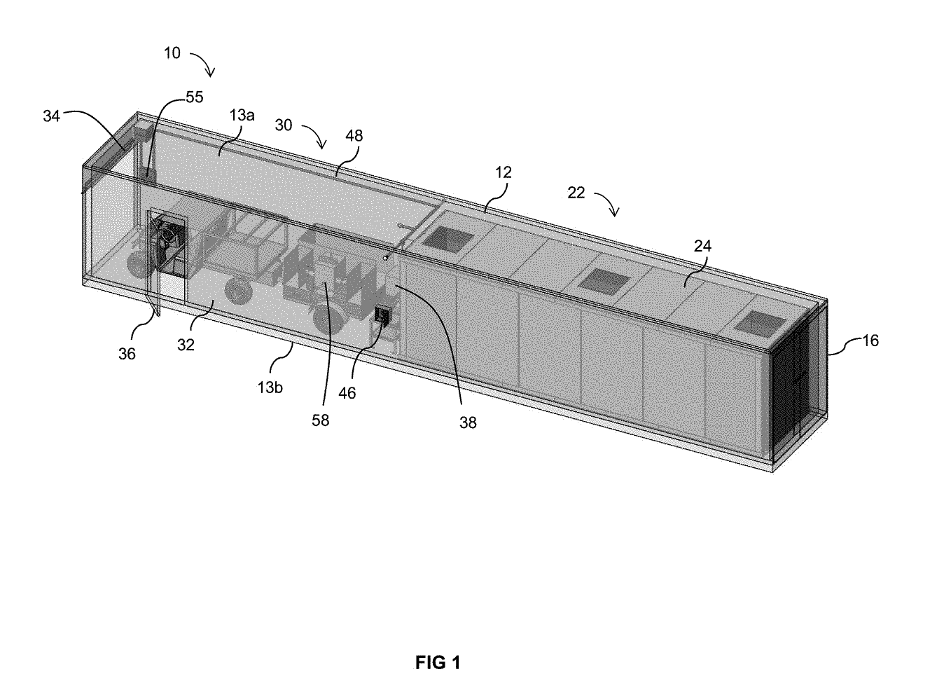

As it will be better understood in view of the following description and referring to FIG. 1, there is provided a mobile firefighting unit 10 in accordance with one embodiment of the present invention. In the embodiment shown, the mobile firefighting unit 10 is provided in the form of a container 12. It is also contemplated that the mobile firefighting unit 10 can be provided in the form of a moveable shelter or any other suitable moveable housing. In the embodiment shown, the container 12 receives the various components required for proper operation of the mobile firefighting unit 10. Thus, it is to be understood that the mobile firefighting unit 10 is self-contained in the container 12.

The container 12 can be a freight container, a shipping container or an intermodal container. In one variant, the container 12 can have a length of about 40 feet. In another variant, it is contemplated that the container can have a length of about 53 feet. The use of a shipping container 12 to form the mobile firefighting unit 10 can be advantageous in the sense that shipping containers are widely available, tough, weather-resistant, have suitable interior space for the components of the mobile firefighting unit 10 and can be transported conveniently. For instance, the mobile firefighting unit 10 can be transported or moved using freight transportation equipment, such as a crane, a truck bed, a train wagon, an airplane, a helicopter or a boat. Thus, the mobile firefighting unit 10 is understood to be conveniently movable from one location to another.

It will be understood that the container 12, moveable shelter, or other suitable moveable housing is characterized as being “moveable” in that it can be transported conveniently to various geographical locations using commonly known transportation means. For example, the container 12, moveable shelter, or other suitable moveable housing may be moved from one protected site to another protected site. However, when deployed at a particular protected site, the container 12, moveable shelter, or other suitable moveable housing will be substantially stationary and will not be displaced for firefighting purposes to firefighting sites within the protected site.

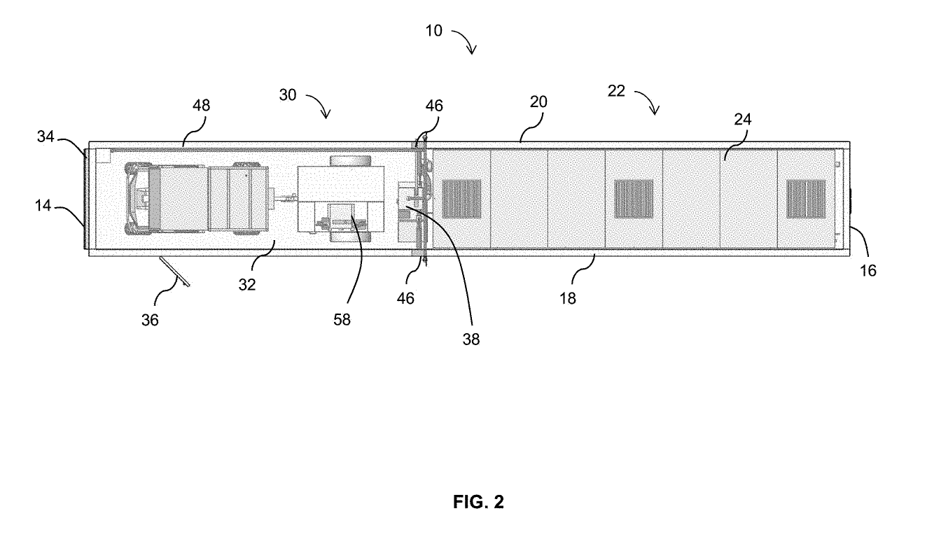

Referring now to FIGS. 1 and 2, therein illustrated is a perspective partially translucent view and plan view of a mobile firefighting unit 10 according to one example embodiment. It is understood that the container 12 includes a top wall 13a, a bottom wall 13b, a front wall 18, a rear wall 20, a left end wall 14 and a right end wall 16. The front and rear end walls 18, 20 are substantially larger than the left and right end walls 14, 16. In addition, all the walls 14, 16, 18, 20, and the top and bottom walls, comprise an interior face and an exterior face. While the left end wall 14 and right end wall 16 have generally been described as being walls, it will be understood that one or more of the left end wall 14 and right end wall 16 may be formed of one or more doors that provide access to the inside of the container 12.

Inside the container 12, there are provided two main portions: a reservoir portion 22 for storing a fluid, and a utility portion 30 for receiving the other components of the mobile firefighting unit 10.

The reservoir portion 22 comprises a reservoir 24. The reservoir 24 can be made of suitable materials, such as polymers or metallic alloys, for storing a fluid. In one variant, the reservoir 24 is made of aluminium. Typically, the fluid stored in the container 12 is water. The reservoir 24 can be dimensioned in accordance with the available interior space of the container 12. Thus, the reservoir 24 can have a capacity of several thousands of gallons of water. For instance, as shown in FIGS. 1 and 2, if the container is about 40 feet long, the reservoir 24 can have a capacity of about 12,000 US gallons (about 45 425 litres). In another variant, wherein the container 12 has a length of about 53 feet, the reservoir 24 can have a capacity of about 20,000 US gallons (about 75 708 litres). Water can be stored in the reservoir 24 mainly for the purpose of firefighting. In some scenarios, drinking water can be stored in the reservoir for human consumption. In yet another scenario, water can be stored in the reservoir for the purpose of irrigating crops. The reservoir portion 22 of the mobile firefighting unit 10 can occupy a majority of the interior space of the container 12 for maximising water storage, and thus maximising the firefighting capabilities of the mobile firefighting unit 10.

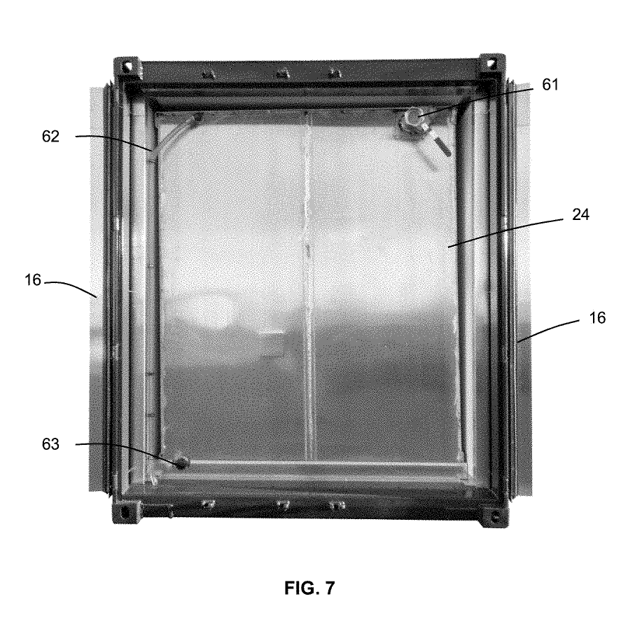

Referring to FIG. 7, the right end wall 16 may include container doors 60. The container doors 60 provide convenient access to the interior of the container 12 and can be used to access the reservoir 24. As illustrated, an inlet 61 of the reservoir 24 may be used to fill the reservoir 24. The reservoir 24 may further include an overflow drain 62 which allows exit flow of fluid when the reservoir 24 is filled past capacity. The reservoir may further include an outlet drain 63 for emptying the reservoir 24.

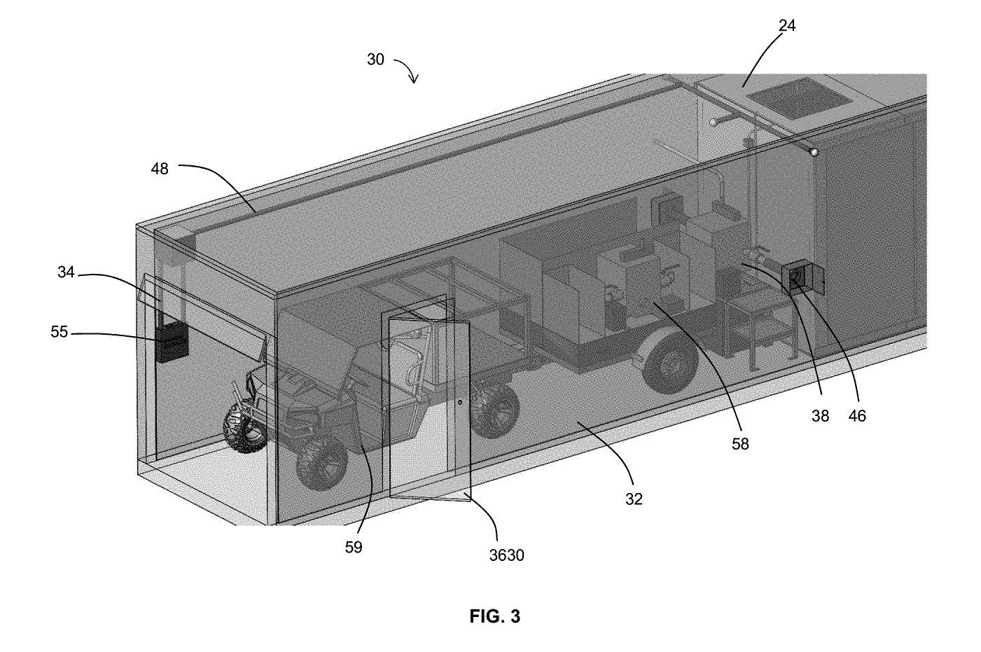

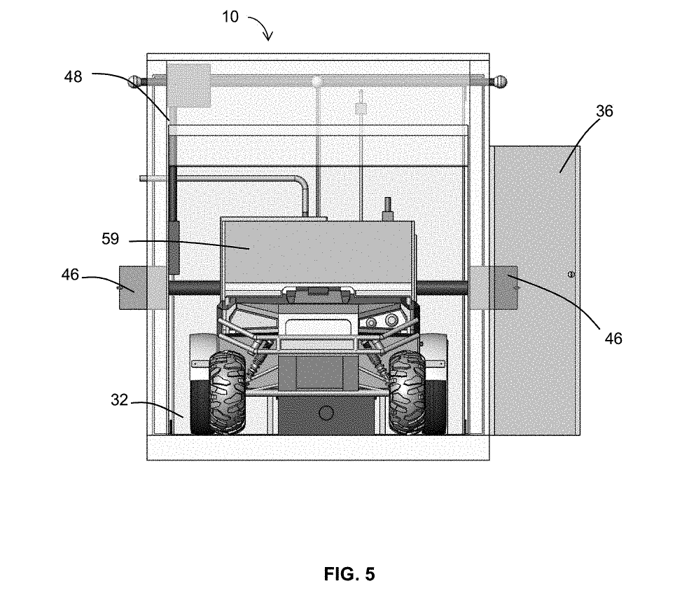

Referring to FIGS. 3, 4 and 5, the utility portion 30 of the mobile firefighting unit 10 is described. The utility portion 30 mainly comprises a utility room 32. Access to the utility room 32 is provided by a primary door 34 and a secondary door 36. The primary door 34 may be a garage door. The primary door 34 may be defined in the front wall 18 of the container 12. Alternatively, and as illustrated, the primary door 34 may be defined in the left end wall 14 of the container 12. The primary door 34 can allow convenient access to the utility room 32. The secondary door 36 may be a standard 32-inches wide door. The secondary door 36 may be defined in the same front wall 18 as the primary door 34, or otherwise.

The utility portion 30 includes a main pumping station 38 located inside the utility room 32. The utility portion 30 further includes a motor for driving the main pumping station 38, which motor may be installed in the utility room 32. The motor can be powered by a consumable fuel, such as being a gas or diesel motor. For instance, an internal combustion engine with a power output of between about 20 and 35 horsepower is contemplated as a suitable motor. The main pumping station 38 is in fluid communication with the reservoir 24. The main pumping station 38 includes at least one primary outlet 40, a secondary outlet 42 and one inlet 43. For instance, each outlet 40, 42 can be of about 2.5 inch in diameter and the inlet can be of about 4 inches in diameter. Each primary outlet 40 of the main pumping station 38 includes a distribution valve 44 for dispensing water to a distribution outlet 46 (shown in FIG. 3) that is located on an exterior face of one of the walls of the container 12. Thus, a primary hose extending outside the container 12 may be connected to one of at least one distribution outlet 46 and allow for water pumped from the reservoir 24 to be used for firefighting purposes.

A valve 45 of the inlet 43 allows for selective providing flow of fluid from the reservoir 24 to the inlet 43. In one example, and as illustrated, the inlet 43 is connected to a lower portion of the reservoir 24. When the valve 45 is actuated to allow passage of fluid, the force of gravity causes the fluid to flow into the main pumping station 38. Accordingly, the placement of the inlet 43 at the lower portion of the reservoir 24 provides the main pumping station 38 with a self-priming function when receiving fluid from the reservoir 24.

According to the illustrated example, a distribution outlet 46 is provided on each of the rear wall 20 and front wall 18 and is each connected to the main pumping station 38 via a respective distribution valve 44. During deployment for firefighting purposes, the primary hose may be connected to either one of the distribution outlets 46 and fluid from the reservoir 24 may be selectively provided to that outlet 46 by opening the valve 44 corresponding to that outlet 46. An operator may choose to connect the primary hose to the distribution outlet 46 that is located on the rear wall 20 or front wall 18 that is closest to the firefighting site to be served.

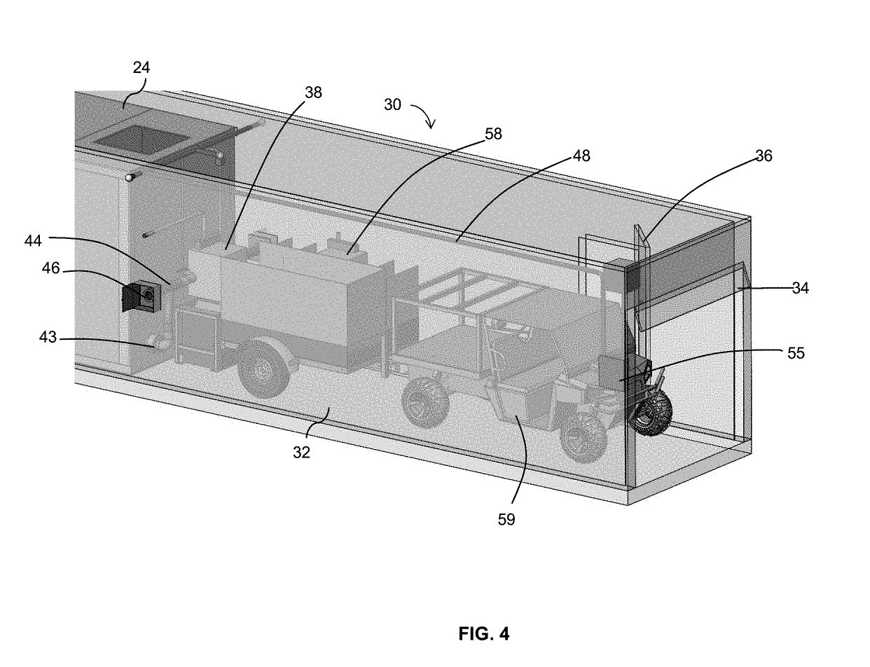

Referring to FIG. 4, the secondary outlet 42 of the main pumping station 38 is connected to the reservoir 24 and allow for recirculation of the water contained inside the reservoir 24 or, if the inlet is connected to a water source, the secondary outlet 42 can be used to fill the reservoir 24 with water pumped from said water source. Recirculation of the water using the secondary outlet 42 can be used to avoid overheating of the main pumping station 38 during operation thereof and to avoid pressure buildup in the main pumping station 38. The secondary outlet 42 is preferably always open to avoid such issues.

The mobile firefighting unit 10 includes a mobile pumping station 58 suitable for firefighting purposes. The mobile pumping station 58 can be powered by an internal combustion engine having a power output of between about 20 and 35 horsepower for moving fluid. The mobile pumping station 58 can further include firefighting equipment, such as one or more secondary hoses, tools and handheld fire extinguishers, for rapid intervention of the firefighting personnel if a fire occurs.

It is contemplated that the mobile pumping station 58 can be provided on a trailer, such as a wheeled trailer, or in an autonomous vehicle in order to be ready to be deployed for firefighting purposes. When the mobile firefighting unit 10 is in a deployment-ready state, the trailer or the autonomous vehicle is parked in the utility room 32 next to the primary door 34 for rapid deployment.

According to some example embodiments wherein the mobile pumping station 58 is provided on a trailer, the mobile firefighting unit 10 can further include a powered vehicle 59 that is operable to tow the wheeled trailer supporting the mobile pumping station 58. For example, the powered vehicle can be a side-by-side (Utility task vehicle) or similar type of vehicle. When the mobile firefighting unit 10 is in a deployment-ready state, the powered vehicle 59 can also be parked in the utility room 32 next to the primary door 34 for rapid deployment, as illustrated.

The mobile pumping station 58 is displaceable to a location outside of the container 12. In particular, the mobile pumping station 58 is displaceable to a firefighting site within the protected site that is located remotely of the container 12. A firefighting site is considered to be located remotely of the container 12 if it cannot be directly served for firefighting purposes from the container 12 (ex: if the container 12 acted as a fire hydrant), and can only be served using the mobile pumping station 58. In one example, the mobile pumping station 58 can be displaced by operating the autonomous vehicle that is supporting the mobile pumping station 58. Alternatively, the mobile pumping station 58 can be displaced by operating the powered vehicle towing 56, the trailer or operating an external vehicle (ex: car, truck, snowmobile, etc) that can be coupled to the trailer to tow it.

As described elsewhere herein, a primary hose is connectable to one of the one or more distribution outlets 46 to receive fluid from the reservoir 24. Furthermore, when so connected, the primary hose is extending outside the container 12. It will be further understood that when the mobile firefighting unit 10 is in its deployment-ready state, the primary hose may be stored within the utility room 32. It will be appreciated that storage within the utility room 32 protects the primary hose from environmental conditions outside of the container 12 that may cause wear and tear or damage the primary hose, such as extreme cold temperatures or extreme hot temperatures.

According to various example embodiments, the primary hose is carried with the mobile pumping station 58. Accordingly, as the mobile pumping station 58 is displaced, a portion of the primary hose is also being displaced with the mobile pumping station. It will be appreciated that a portion of the primary hose is always co-located with the mobile pumping station 58 as the mobile pumping station 58 is displaced.

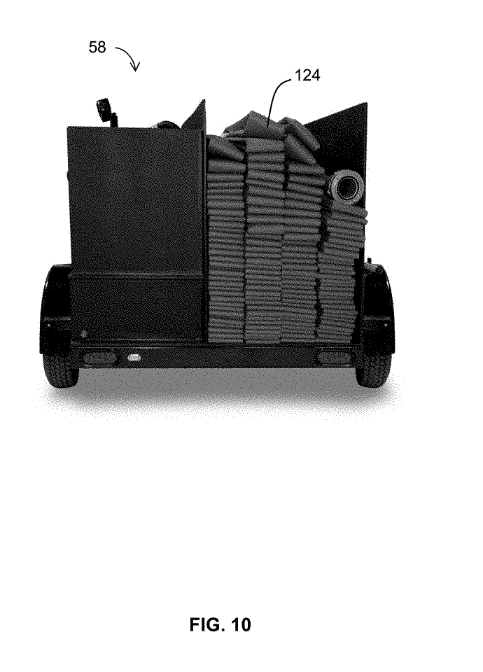

According to various example embodiments, the primary hose is arranged in a bundled form when stored within the utility room 32. The primary hose is bundled in that it assumes a shape that requires less space and can be carried with the mobile pumping station 58. Furthermore, the primary hose is bundled in that it can be easily unbundled to assume a substantially extended shape. For example, the primary hose can be bundled by being folded over itself, as illustrated in FIG. 10, or being spooled about a hose reel.

The primary hose is bundled when the mobile firefighting unit 10 is in the deployment-ready state such that it can be unbundled when the mobile firefighting unit 10 is in deployed state and the mobile pumping station 58 is displaced about the protected site. More specifically, upon the first end of the primary hose being connected to a distribution outlet 46 and the mobile pumping station 58 being displaced, the connected first end pulls on the bundled primary hose such that the primary hose is gradually unbundled as the mobile pumping station 58 is displaced. Furthermore, a bundled portion of the primary hose continues to be carried with the mobile pumping station 58 as it is being displaced. Accordingly, as the mobile pumping station 58 is displaced, the first end of the mobile pumping station 58 is constantly connected to the distribution outlet 46, an bundled portion of the primary house is constantly co-located with the mobile pumping station 58 and the unbundled portion of the primary hose provides a fluid path between the distribution outlet 46 and the bundled portion.

According to one example, the primary hose is formed of a plurality of discrete hose segments that is connectable and disconnectable from one another. The discrete hose segments are connected end to end when stored in the utility room 32 while the mobile fighting unit 10 is in its deployment-ready state. When being deployed for firefighting purposes, two adjacently connected hose segments can be disconnected from one another to separate the connected primary hose into two portions. For example, the separation may be made along a length of the primary hose corresponding to the boundary between the portion of the primary hose that has been unbundled and the portion of the primary hose that is still bundled and being carried with the mobile pumping station 58. The unbundled portion of the primary hose becomes effective for providing the fluid path between the container 12 and the mobile pumping station 58. It will be appreciated that providing the primary hose as an assembly of connected hose segments allows the primary hose to allow flow of water through the bundled portion extending from the distribution outlet 46 at the container 12 to the mobile pumping station 58 at the firefighting site without having to further unbundled the portion of the primary hose that is still bundled.

In one example embodiment, the primary hose has a length of at least about 1400 ft.

In one example embodiment, the primary hose has a length of about 1400 ft to about 2800 ft.

In one example embodiment, the primary hose has a diameter of about 4 inches.

The primary hose may be formed of discrete segments each having a length of substantially less than 100 ft. For example, the primary hose may be formed of discrete segments each having a length of approximately 50 ft. It was observed that using discrete segments that each have a length substantially less than 100 ft allowed for more easily making a separation between two adjacently connected hose segments. It will be appreciated that a given two adjacently connected hose segments are accessed only as the primary hose is unbundled as the mobile pumping station 58 is displaced. It was observed that having segments of 100 ft or more often required unnecessarily displacing mobile pumping station 58 past a firefighting site (or making an unnecessarily large loop) in order to unbundled the required length of primary hose. Having segments of less than 100 ft (ex: 50 ft) allowed for easier access to the appropriate end segment of primary hose to be connected to the mobile pumping station.

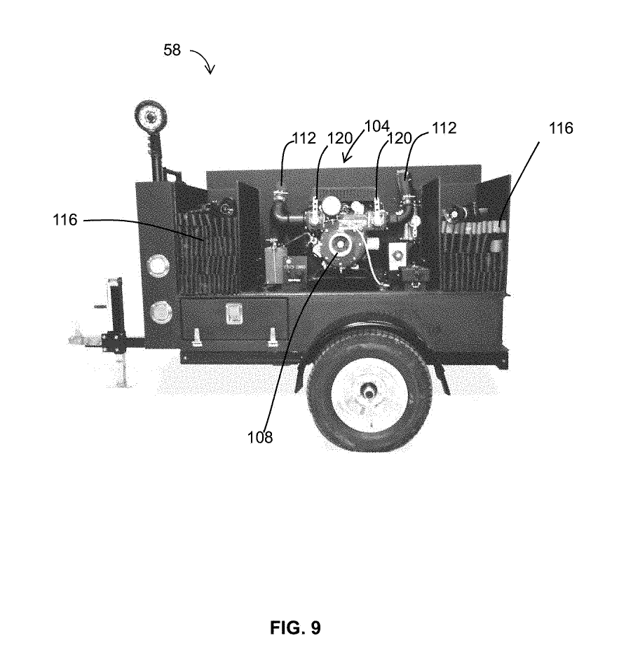

Referring now to FIGS. 9 and 10, therein illustrated is a side elevation view and a rear elevation, respectively, of the mobile pumping station 58 according to one exemplary embodiment. The mobile pumping station 58 includes a motorized pump 104 having an inlet 108 and at least one outlet 112. According to the illustrated example, two outlets 112 are provided. The mobile pumping station 58 further includes at least one secondary hose 116 each being connected to an outlet 112. As illustrated, two secondary hoses 116 are provided. The inlet 108 of the mobile pumping station 58 is connectable to the primary hose to receive fluid therefrom. Fluid received from the primary hose is moved by the motorized pump 104 and outputted to the at least one secondary hose 116. The at least one secondary hose 116 may be configured to eject the fluid. The secondary hose may be operable to eject the fluid as a jet suitable for fighting fire. The mobile pumping station 58 may further include a distribution valve 120 for each outlet to selectively control flow of fluid to the at least one secondary hose 116.

The mobile pumping station 58 is supported on a mobile platform. According to the example illustrated in FIGS. 9 and 10, the mobile platform is a wheeled trailer. The at least one secondary hose 116 is also supported by the mobile platform. The mobile pumping station 58 is further illustrated while in its deployment-ready state. In such a state, each of the at least one secondary hose 116 is arranged in a bundled form to be carried on the mobile platform while allowing for convenient unbundling. As illustrated, a compartment is provided on the mobile platform for storing each of the secondary hose 116.

According to one example embodiment, the mobile pumping station 58 further includes at least one mobile reservoir for storing foam suitable for firefighting. The mobile pumping station 58 is further configured to selectively mix the fluid received from the reservoir 24 of the container 12 with the foam from the mobile reservoir to form a mixture effective for fighting fire. The mixture may be ejected from at least one secondary hose 116.

The mobile pumping station 58 may include two or more mobile reservoir that each stores foam having a different composition. For example, a first mobile reservoir of the mobile pumping station 58 may store a general-purpose firefighting foam that increases efficacy when mixed with fluid and a second mobile reservoir of the mobile pumping station 58 may store a specialty firefighting foam that is effective for firefighting where the fire is burning more volatile material, such as petrochemical materials, electrical components, etc.

According to one example embodiment, the secondary hose has a length about at least 50 ft.

According to one example embodiment, the secondary hose has a length of about 100 ft.

According to one example embodiment, the secondary hose has a length of about 150 ft.

According to one example embodiment, the secondary hose has a length of about 200 ft.

Where two or more secondary hoses are provided within the mobile pumping station 58, the secondary hoses may have different length according to requirements of the protected site.

The secondary hose 16 is sized and weighted so as to be carried by firefighting personnel.

As described elsewhere herein, according to various example embodiments, the primary hose is carried with the mobile pumping station 58. According to the illustrated example, the mobile platform includes a compartment for storing the primary hose 124. It will be appreciated that the primary hose 124 is arranged in a bundled form when the mobile pumping station 58 is in its deployment-ready state.

According to various example embodiments, the mobile platform may have coupled thereto additional firefighting equipment, such as axes, handtools, handheld extinguishers, power tool, nozzles and fittings.

In some scenarios, in the event of a fire, the mobile pumping station 58 is deployed by firefighting personnel and is connected to the distribution outlet 46 using a suitable primary hose extending outside the container 12. For instance, the primary hose can have 4 inches in diameter. The primary hose can be of several hundred feet. The mobile pumping station 58 is to be understood as being a mobile fire hydrant. The mobile pumping station 58 receives, through the primary hose, fluid pumped from the reservoir 24 by the main pumping station 38 with a high flow rate (ex: about 350 gallons per minute or more) and a low pressure (ex: about 50 psi or less), and further pump said water to a high pressure (ex: 150 psi or more) with a high flow rate (ex: 150 gallons per minute or more), suitable for the firefighting personnel to attack a fire from a nearby location using one or more firefighting secondary hoses. Thus, the mobile firefighting unit 10 can include the main pumping station 38 and the mobile pumping station 58 arranged in serial configuration for advantageous firefighting capabilities in an area around said mobile firefighting unit 10.

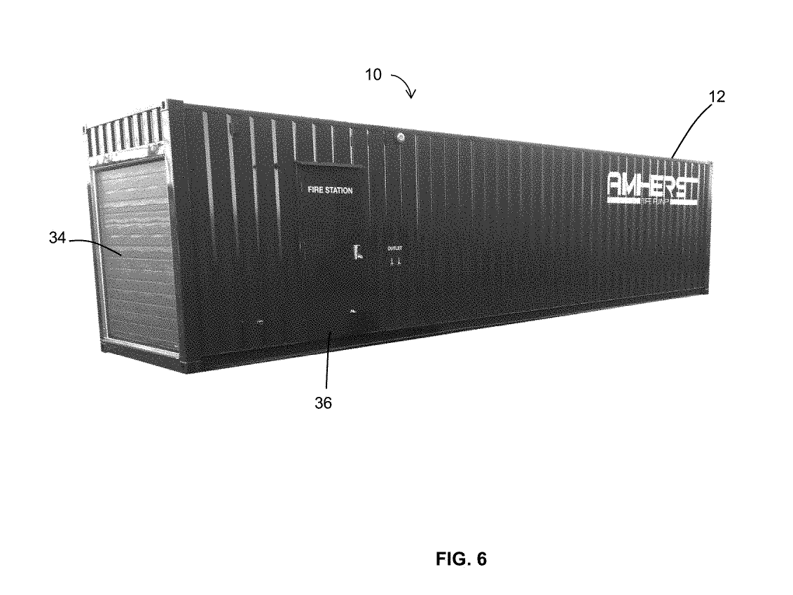

It is also understood that several mobile firefighting units 10 can be installed at different locations in an area, and thus provide increased firefighting capabilities over said area. In the embodiment shown in FIGS. 2 and 6, a backup pump 54 is provided inside the utility room 32. The backup pump 54 may be used in the event the pump of the mobile pumping station 58 has issues. The backup pump 54 may also be used within the mobile pumping station 38. Furthermore, the backup pump 54 may be used for filling the reservoir 24, such as pumping fluid into the reservoir 24 from a nearby body of water.

According to various example embodiments for operating the mobile firefighting unit 10, the mobile firefighting unit 10 is initially prepared to its deployment-ready state. In this state, the container 12 is placed at a location effective for serving a protected site. The reservoir 24 of the container 12 is further maintained to store sufficient fluid to for fighting a fire. The mobile pumping station 58 and the primary hose are further stored in the utility room 32 of the utility portion 24 of the container 12. The powered vehicle 59, where supplied, for towing the mobile pumping station 58 supported on a trailer, may also be stored in the utility room 32. The environmental conditions within the utility room 32 are maintained to ensure proper functioning of the main pumping station 38, mobile pumping station 58, and primary hose 124. For example, a heating or cooling of the utility room 32 can be provided. Furthermore, the primary hose and the secondary hose are both arranged in their bundled form and ready to be carried with the mobile pumping station 58.

In response to a firefighting emergency, one or more firefighting personnel accesses the utility room 32 through the primary door 34 or secondary door 36. The mobile pumping station 58 is displaced by firefighting personnel from the utility room 32 of the utility portion 24 of the container 12 to a location outside of the container 12, such as through the primary door 34.

Where the primary hose is not yet connected to an outlet of the main pumping station 38, a first end of the primary hose is connected to a distribution outlet 46 by firefighting personnel. The firefighting personnel may choose to connect the distribution outlet 46 that is located closest to the firefighting site to be served.

The mobile pumping station 58 is further displaced to the firefighting site that is located remotely of the container. It will be understood that the mobile pumping station 58 is displaced while the first end of the primary hose 124 is connected to the distribution outlet 46 at the container 12. As the mobile pumping station 58 is being displaced, the primary hose 124 is gradually being unbundled and laid over the path traveled by the mobile pumping station 58.

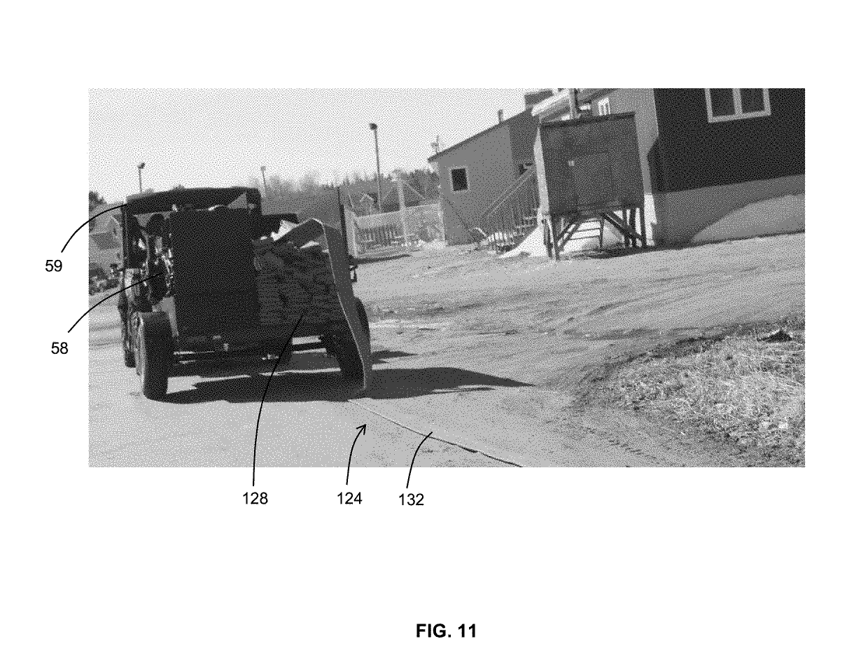

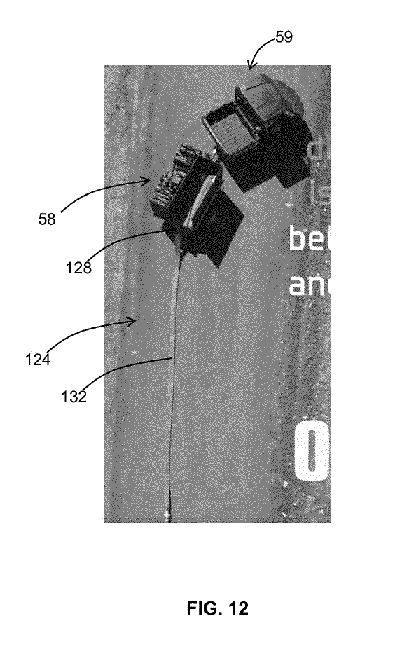

FIGS. 11 and 12 illustrate a perspective view and plan view of the mobile pumping station 58 as it is being displaced, showing a bundled portion 128 of the primary hose 124 still be carried with the mobile pumping station 58 and an unbundled portion 132 being laid out over the path traveled by the mobile pumping station 58 between container 12 and its current location.

Upon arriving at the firefighting site, the main pumping station 38 at the container 12 is operated to begin providing fluid from the reservoir of the container to the mobile pumping station 58 via the primary hose 124. One of the firefighting personnel stays back at the container and operates the main pumping station 38 to begin providing fluid in response to a signal from another personnel indicating that the mobile pumping station 58 has reached the firefighting site.

According to various example embodiments wherein the primary hose 124 hose is not initially attached to the inlet of the mobile pumping station 58, the primary hose 124 is attached to the inlet upon the mobile pumping station 58 arriving at the firefighting site.

According to various example embodiments wherein the primary hose 124 is provided as a plurality of discrete hose segments connected end-to-end, the firefighting personnel disconnects two adjacently connected hose segments along a length of the primary hose 124 corresponding to the boundary between the portion of the primary hose that has been unbundled and the portion that is still bundled. An end of the unbundled portion is connected to the inlet of the mobile pumping station 58 and fluid from the container 12 travels over the unbundled portion 132 of the primary hose only to reach the mobile pumping station 58.

The mobile pumping station 58 is further operated by a firefighting personnel to cause fluid received from the container 12 over the primary hose to be exited from at least one secondary hose 116. The fluid is exited from the at least one secondary hose as at least one jet that is suitable for firefighting.

It will be appreciated that in operation, a serial connection forming a fluid path is formed from the reservoir 24 being connected to the main pumping station 38, which is further connected to the primary hose 124, which is further connected to the mobile pumping station 58, which ejects the fluid from its at least one secondary hose.

Referring back to FIGS. 1 to 5, the utility portion 30 further includes an electric panel 55. The electric panel 55 is located on the interior face of the rear wall 20. The electric panel 55 is used for energising various components of the mobile firefighting unit 10. The electric panel 55 can be linked to a power source through a mast 48 passing through the top wall of the container 12. Power sources can include at least one of main power lines, solar panels and suitable electric generators. The electric panel 55 has, for instance, a capacity of 60 amps. It is contemplated that solar panels can be installed on the top wall of the container 12 to provide a current of about 20 amps, which can be suitable for starting the motor of the main pumping station 38. In one variant, the electric panel 55 is also linked to a battery array for storing energy.

The walls of the container 12, i.e. the top, bottom, front 18, rear 20, left end 14 and right end 16 walls, are insulated. For instance, suitable insulating materials, such as urethane, may be applied on the interior face of one or more of the walls of the container 12. In some examples, insulating material may be applied outside the container 12, such as underneath the bottom wall. Providing the insulating materials on the interior faces of the walls of the container 12 can prevent degradation of said insulating materials due to vandalism, animals and/or wear due to external exposition. Thus, the temperature inside the container 12 can be regulated using a heating system. For example, the heating system can include at least one of an electric heater unit and an air conditioning unit. The heating system is energised by the electric panel 55. In the event the mobile firefighting unit 10 is used in a cold-weather environment, the insulating materials and/or the heating system 50 can prevent the water stored inside the reservoir 24 to freeze. Similarly, the insulating materials may prevent overheating of elements within the utility room 32 where the mobile firefighting unit 10 is used in warm-weather environments. The utility room 32 can thus further provide shelter.

The utility room 32 may further include storage unit used to store various firefighting equipment, such as handheld extinguishers, hand tools, power tools, hoses, nozzles and fittings.

The mobile firefighting 10 unit further includes a lighting system for lighting the utility room 32 and/or the exterior of the container 12. The lighting system is energised by the electric panel 55 of the mobile firefighting unit 10. The lighting system can include, for instance, LED lights installed both inside the utility room 32 and on the exterior faces of the front 18, rear 20, left end 14 and right end 16 walls of the container 12. Low power lighting systems, such as LED lights, can be advantageous to decrease power consumption in the event the mobile firefighting unit 10 is powered by an electric generator.

The mobile firefighting unit 10 may further include an alarm system comprising one or more levers mounted on the exterior faces of the front 18, rear 20, left end 14 and right end 16 walls of the mobile firefighting unit 10, and an alarm siren. In the event of a fire, a citizen or firefighting personnel can activate the alarm siren by pulling one of the levers, and thus provide an alarm signal to wake-up people and for rallying the firefighting personnel at the mobile firefighting unit 10 for rapid deployment of the firefighting equipment provided therein.

The mobile firefighting unit 10 may further include a monitoring system that monitors various conditions of the mobile firefighting unit 10. Such conditions may include the level of fluid left within the reservoir 24, whether the primary door 34 and or secondary door 36 have been opened, the pressure within the main pumping station 38 and/or secondary pumping station 58. The monitoring system may be used to monitor whether the mobile firefighting unit 10 is ready for deployment or whether it requires maintenance. Conditions monitored may also be used as evidence for investigation purposes after a fire.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention. The scope of the invention is therefore intended to be limited solely by the scope of the appended claims.

1. A mobile firefighting unit for serving a geographical region, the mobile firefighting unit comprising a housing having a reservoir portion and a utility portion, the housing being stationary within the geographical region during operation of the mobile firefighting unit in response to a firefighting situation;
the reservoir portion comprising a reservoir for storing a fluid; and
the utility portion comprising a main pumping station in fluid communication with the reservoir, and a mobile pumping station connectable to the main pumping station through a primary hose extending outside the housing, the mobile pumping station being deployable for firefighting purposes.

2. The mobile firefighting unit of claim 1, wherein the mobile pumping station is deployable for firefighting purposes outside of the housing and at a firefighting site remote of the housing.

3. The mobile firefighting unit of claim 2, wherein, during deployment for firefighting purposes, the mobile pumping station receives the fluid from the reservoir via the primary hose extending outside the housing and connected to the mobile pumping station.

4. The mobile firefighting unit of any one claim 2, wherein the mobile pumping station is displaceable from the housing to the firefighting site remote of the housing while the primary hose is connected to the main pumping station.

5. The mobile firefighting unit of claim 4, wherein the primary hose is initially stored in a bundled form within the utility portion;
and wherein the primary hose is unbundled as the mobile pumping station is displaced to the firefighting site.

6. The mobile firefighting unit of claim 1, wherein the main pumping station is configured to cause flow of the fluid at a high flow rate and low pressure.

7. The mobile firefighting unit of claim 6, wherein the mobile pumping station is configured to cause flow of the fluid at a high pressure and high flow rate.

8. The mobile firefighting unit of claim 1, wherein the mobile pumping station comprises at least one secondary hose, the primary hose being connectable to an inlet of the mobile pumping station and the fluid received via the primary hose being ejected via the at least one secondary hose.

9. The mobile firefighting unit of claim 8, wherein the at least one secondary hose is operable to eject the fluid as a jet suitable for fighting fire.

10. The mobile firefighting unit of claim 1, wherein the mobile pumping station further comprises a foam reservoir for storing a foam suitable for firefighting; and
wherein the mobile pumping station is configured to selectively mix the fluid and the foam.

11. The mobile firefighting unit of claim 1, wherein the mobile pumping station is provided on an autonomous vehicle;
wherein the autonomous vehicle is stored within the utility portion of the housing while the mobile firefighting unit is in a deployment-ready state; and wherein the autonomous vehicle is displaced outside of the housing upon deployment.

12. The mobile firefighting unit of claim 11, wherein the primary hose is carried on the autonomous vehicle.

13. The mobile firefighting unit of claim 1, wherein the mobile pumping station is provided on a trailer;
wherein the trailer is stored within the utility portion of the housing while the mobile firefighting unit is in a deployment-ready state; and
wherein the trailer is displaced outside of the housing upon deployment.

14. The mobile firefighting unit of claim 13, further comprising a powered vehicle for towing the trailer;
wherein the powered vehicle is stored within the utility portion of the housing while the mobile firefighting unit is in a deployment-ready state; and
wherein the powered vehicle is displaced outside of the housing upon deployment.

15. The mobile firefighting unit of claim 14, wherein the primary hose is carried on one of the powered vehicle and the trailer.

16. The mobile firefighting unit of claim 1, wherein the primary hose is formed of a plurality of discrete connected segments, thereby allowing for adjusting an effective length of the primary hose during deployment.

17. A method for operating a mobile firefighting unit for serving a geographical region, the mobile firefighting unit comprising a housing having a reservoir portion and a utility portion, the reservoir portion comprising a reservoir for storing a fluid and the utility portion comprising a main pumping station in fluid communication with the reservoir and a mobile pumping station connectable to the main pumping station through a primary hose extending outside the housing, the method comprising:
displacing the mobile pumping station from the utility portion of the housing of the mobile firefighting unit to a location outside the housing;
further displacing the mobile pumping station to a firefighting site remote of the housing;
after displacing the mobile pumping station to the firefighting site, operating a main pumping station at the housing to begin providing the fluid from the reservoir of the housing to the mobile pumping station via the primary hose;
operating at least one secondary hose of the mobile pumping station to cause the fluid to be exited for firefighting; and
wherein the housing is stationary within the geographical region during operation of the mobile firefighting unit.

18. The method of claim 17, further comprising connecting the primary hose to an outlet of the main pumping station.

19. The method of claim 18, wherein the primary hose is connected to the outlet of the main pumping station after displacing the mobile pumping station to the location outside the housing and prior to displacing the mobile pumping station to the firefighting site remote of the housing.

20. The method of claim 17, wherein a portion of the primary hose is carried with the mobile pumping station as the mobile pumping station is displaced to the firefighting site.

21. The method of claim 20, wherein the primary hose is initially stored with the mobile pumping station in a bundled form; and
wherein the primary hose is unbundled as the mobile pumping station is displaced to the firefighting site.

22. The method of claim 21, wherein the primary hose is formed of a plurality of discrete connected segments, the method further comprising:
after displacing the mobile pumping station to the firefighting site, disconnecting two connected segments corresponding to an unbundled length of the primary hose; and
connecting an end of the unbundled length of the primary hose to an inlet of the mobile pumping station, the fluid being provided to the mobile pumping station via the unbundled length of the primary hose.

23. The mobile firefighting unit of claim 1, wherein the housing is one of a shipping container and a moveable shelter.
